(19) United States
(12) Patent Application Publication
(10) Pub. No.: US 2020/0249738 A1
(43) Pub. Date: Aug. 6, 2020

(54) SYSTEMS AND METHODS FOR ISOLATION OF A POWER-COMPROMISED HOST INFORMATION HANDLING SYSTEM TO PREVENT IMPACT TO OTHER HOST INFORMATION HANDLING SYSTEMS DURING A PERSISTENT MEMORY SAVE OPERATION

(71) Applicant: Dell Products L.P., Round Rock, TX (US)

(72) Inventors: Aaron M. RHINEHART, Georgetown, TX (US); Kyle E. CROSS, Austin, TX (US); Aaron D. CARPENTER, Austin, TX (US)

(73) Assignee: Dell Products L.P., Round Rock, TX (US)

(21) Appl. No.: 16/266,597

(22) Filed: Feb. 4, 2019

(51) Int. Cl. G06F 1/30; G06F 11/14

(52) U.S. Cl. CPC G06F 1/30; G06F 11/1441

(57) ABSTRACT

A method may be provided for use in a chassis configured to provide a common hardware infrastructure to a plurality of modular information handling systems inserted into the chassis. The method may include monitoring a health of a local energy storage device of a modular information handling system of the chassis during runtime of the modular information handling system and in the event of a power event of the chassis which triggers a persistent save operation for the plurality of modular information handling systems of the chassis, allowing the modular information handling system to participate in the persistent save operation if the local energy storage device of the modular information handling system is healthy, and disallowing the modular information handling system to participate in the persistent save operation if the local energy storage device of the modular information handling system is unhealthy.

### TECHNICAL FIELD

The present disclosure relates in general to information handling systems, and more particularly to methods and systems for isolation of a power-compromised information handling system to prevent impact to other host information handling systems during a persistent memory save operation.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems are increasingly using persistent memory technologies such as Non-Volatile Dual In-line Memory Modules (NVDIMMs). An NVDIMM is a memory module that may retain data even when electrical power is removed whether from an unexpected power loss, system crash, or from a normal system shutdown. To enable such functionality, an NVDIMM may include a traditional dynamic random access memory (DRAM) which may store data during normal operation when electrical power is available from one or more power supply units and a flash memory to back up data present in the DRAM when a loss of electrical power from the power supply units occurs. A battery, capacitor, or other energy storage device either internal or external to the NVDIMM may supply electrical energy for a “save” operation to transfer data from the DRAM to the flash memory in response to a power loss event from the power supply units. The transfer of data from DRAM to flash memory is not typically visible to an operating system executing on an information handling system, instead being performed as a background operation on the NVDIMM itself.

In some instances, persistent memory on a server node is powered by a local power source during a save operation. In a modular chassis ecosystem there may be multiple Persistent Memory Equipped (PME) information handling system sleds, each with a local power source (e.g., battery backup unit (BBU), super cap, or other energy storage device). Chassis infrastructure, such as fans or other monitoring hardware, may be required to be powered during the save operation. If all of these local power sources are providing power to a common system voltage rail during the save operation, to power the required chassis infrastructure, the failure of a single local power source may have a detrimental effect on the other PME server nodes in the ecosystem, possibly leading to a loss of data on multiple modular information handling systems.

Each information handling system sled in a modular chassis may be configured to include persistent memory, but only those that are equipped with persistent memory which requires a local power source may participate in a persistent memory save (PM Save) operation after a chassis unexpectedly loses external power. During the PM Save operation, certain portions of the chassis infrastructure may be required to be powered from the chassis common system voltage rail. All of the local power sources are tied together at the main chassis common system voltage rail, and current sharing is enabled between the power sources. Each local sled power source may be sized to power the local server and the chassis infrastructure for the time duration of the persistent memory save operation.

Typically using traditional approaches, local information handling system sled power sources are not sized to support operation of one or more parallel nodes with failed power sources. If a single local sled power source fails during a persistent memory save operation, and if the total power capacity of the remaining local sleds is insufficient to meet the total power requirements of the chassis infrastructure, the non-failed information handling system sleds, and the failed information handling system sled, the save operation may fail, the chassis may shut down, and data may be lost for all information handling system nodes.

Performing save operations in such manner may leave a few instances in which data persistency may be put at risk. One situation is when electrical power is unexpectedly removed from an information handling system. Another situation is when electrical power returns unexpectedly following an unexpected power loss. Both of these situations may lead to data loss if not properly handled. In a monolithic server, a battery-backed NVDIMM must immediately flush its contents to flash, while preventing the information handling system from powering back on until the save operation is completed.

These problems are amplified in a chassis environment in which a chassis may receive one or more modular host information handling systems (e.g., sleds). For instance, in a chassis environment, the system must figure out if persistency of memory can be safely enabled and interlock modular sleds so that memory persistency is not enabled if unsafe to do so. In a chassis environment, each individual modular sled may have a battery backup. Upon a power loss, the battery backup may back-feed power to the main power rails of the chassis. If this situation is present, it is not safe for power from power supply units to return to the main power rails as it could cause damage to the batteries and/or glitches that result in data loss.

In addition, an information handling system configured without persistent memory may try to “ride through” brownout conditions in hopes that sufficient power will be restored to continue normal operation before power supply units completely cease to deliver energy. However, when an information handling system is installed in a chassis environment, and that information handling system is configured with persistent memory present and enabled, the ride through behavior of other information handling systems in the chassis configured without persistent memory may need to be curtailed to retain enough energy to start the save operation.

### SUMMARY

In accordance with the teachings of the present disclosure, the disadvantages and problems associated with existing approaches to maintaining persistent memory in a chassis environment may be reduced or eliminated.

In accordance with embodiments of the present disclosure, a method may be provided for use in a chassis configured to provide a common hardware infrastructure to a plurality of modular information handling systems inserted into the chassis. The method may include monitoring a health of a local energy storage device of a modular information handling system of the chassis during runtime of the modular information handling system and in the event of a power event of the chassis which triggers a persistent save operation for the plurality of modular information handling systems of the chassis, allowing the modular information handling system to participate in the persistent save operation if the local energy storage device of the modular information handling system is healthy, and disallowing the modular information handling system to participate in the persistent save operation if the local energy storage device of the modular information handling system is unhealthy.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to, in a chassis configured to provide a common hardware infrastructure to one or more modular information handling systems inserted into the chassis monitor a health of a local energy storage device of a modular information handling system of the chassis during runtime of the modular information handling system. Also, the instructions may be configured to, in the event of a power event of the chassis which triggers a persistent save operation for the plurality of modular information handling systems of the chassis: allow the modular information handling system to participate in the persistent save operation if the local energy storage device of the modular information handling system is healthy; and disallow the modular information handling system to participate in the persistent save operation if the local energy storage device of the modular information handling system is unhealthy.

In accordance with these and other embodiments of the present disclosure, an information handling system may include a chassis configured to provide a common hardware infrastructure to one or more modular information handling systems inserted into the chassis and a modular information handling system inserted into the chassis. The modular information handling system may be configured to monitor a health of a local energy storage device of the modular information handling system during runtime of the modular information handling system. The modular information handling system may also be configured to, in the event of a power event of the chassis which triggers a persistent save operation for the plurality of modular information handling systems of the chassis: allow the modular information handling system to participate in the persistent save operation if the local energy storage device of the modular information handling system is healthy; and disallow the modular information handling system to participate in the persistent save operation if the local energy storage device of the modular information handling system is unhealthy.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system, in accordance with embodiments of the present disclosure;

FIG. 2 illustrates a flow chart of an example method for monitoring health of a local energy storage device of an information handling system, in accordance with embodiments of the present disclosure; and

FIG. 3 illustrates a flow chart of an example method for save operation by an information handling system, in accordance with embodiments of the present disclosure.

### DETAILED DESCRIPTION

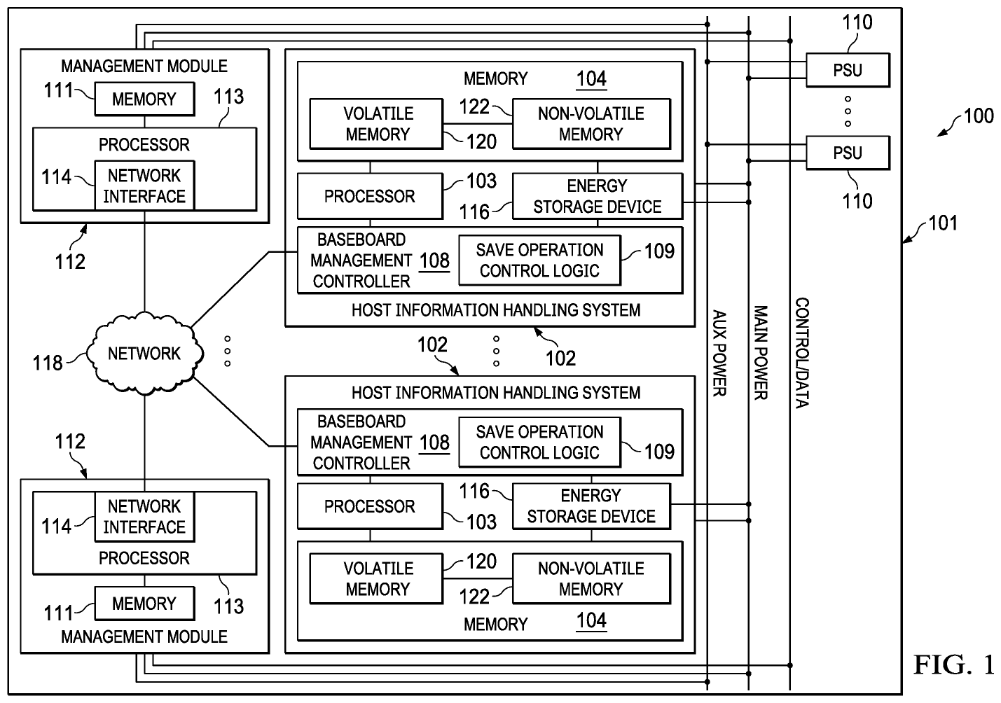

Preferred embodiments and their advantages are best understood by reference to FIGS. 1 through 3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example system 100, in accordance with embodiments of the present disclosure. As shown in FIG. 1, system 100 may comprise a chassis 101 for enclosing a plurality of information handling resources, including a plurality of modular host information handling systems 102 (e.g., sleds), one or more management modules 112, an internal network 118, and a power system comprising one or more power supply units (PSUs) 110.

Chassis 101 may include any suitable enclosure for housing the various components of system 100, and may also be referred to as a rack, tower, enclosure, and/or housing.

As shown in FIG. 1, a host information handling system 102 may include a processor 103, a memory 104 communicatively coupled to processor 103, a baseboard management controller 108 communicatively coupled to processor 103, and an energy storage device 116.

A processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in an associated memory 104 and/or another component of its associated information handling system 102.

A memory 104 may be communicatively coupled to an associated processor 103 and may include any system, device, or apparatus configured to retain program instructions and/or data for a period of time (e.g., computer-readable media). A memory 104 may include RAM, EEPROM, a PCMCIA card, flash memory, magnetic storage, opto-magnetic storage, or any suitable selection and/or array of volatile or non-volatile memory that retains data after power to information handling system 102 is turned off. As shown in FIG. 1, memory 104 may comprise a persistent memory (e.g., comprising one or more NVDIMMs) that includes a volatile memory 120 (e.g., DRAM or other volatile random-access memory) and non-volatile memory 122 (e.g., flash memory or other non-volatile memory). During normal operation, when PSUs 110 provide adequate power to components of information handling system 102, data written to memory 104 from processor 103 may be stored in volatile memory 120. However, in the event of loss of system input power or a power fault of PSUs 110 that prevents delivery of adequate electrical energy from PSUs 110 to memory 104, data stored in volatile memory 120 may be transferred to non-volatile memory 122 in a save operation. After input power is restored, or a faulty PSU 110 is replaced, such that PSUs 110 are again operable to provide sufficient electrical energy to information handling resources of an information handling system 102, on the subsequent power-on of information handling system 102, data may be copied from the non-volatile memory 122 back to volatile memory 120 via a restore operation. The combined actions of data save and then data restore allows the data to remain persistent through a power disruption. Although not explicitly shown in FIG. 1, memory 104 may also include hardware, firmware, and/or software for carrying out save operations.

A baseboard management controller 108 may be configured to provide out-of-band management facilities for management of information handling system 102. Such management may be made by baseboard management controller 108 even if information handling system 102 is powered off or powered to a standby state. In certain embodiments, baseboard management controller 108 may include or may be an integral part of a remote access controller (e.g., a Dell Remote Access Controller of Integrated Dell Remote Access Controller).

As shown in FIG. 1, baseboard management controller 108 may include save operation control logic 109. Save operation control logic 109 may comprise any system, device, or apparatus configured to monitor a health status of an energy storage device 116 of a host information handling system 102 and selectively enable or disable the execution of save operations on such host information handling system 102, as described in greater detail below. Although FIG. 1 depicts save operation control logic 109 as integral to baseboard management controller 108, in some embodiments, save operation control logic 109 may be external to baseboard management controller 108 and may be embodied in a complex programmable logic device or other suitable piece of electronic hardware.

An energy storage device 116 may comprise any system, device, or apparatus configured to store energy which may be used by memory 104 to perform save operations in response to a loss of an input source of energy (e.g., loss of alternating current or direct current source) or other power fault of one or more PSUs 110. In some embodiments, energy storage device 116 may comprise a battery configured to convert stored chemical energy into electrical energy. In other embodiments, energy storage device 116 may comprise a capacitor or “supercap” configured to store electrical energy and deliver such electrical energy to memory 104 when needed to perform save operations (e.g., by closure of a switch to electrically couple such capacitor to components of memory 104). Although energy storage device 116 is shown in FIG. 1 as external to memory 104, in some embodiments energy storage device 116 may be integral to memory 104. In these and other embodiments, energy storage device 116 may be charged from one or more PSUs 110. In some embodiments, an energy storage device 116 may be communicatively coupled to an associated baseboard management controller 108 via a systems management interface such as, for example, Inter-Integrated Circuit (i2C), System Management Bus (SMBus) or Power Management Bus (PMBus), allowing baseboard management controller 108 to receive health and status (e.g., state of charge) from and/or communicate commands to energy storage device 116. In some embodiments, energy storage device 116 may provide energy to a plurality of persistent memory 104 devices.

Although, for the purposes of clarity and exposition, FIG. 1 depicts only two host information handling systems 102 within system 100, it is understood that system 100 may comprise any suitable number of host information handling systems 102.

In addition to a processor 103, a memory 104, a baseboard management controller 108, and an energy storage device 116, a host information handling system 102 may include one or more other information handling resources. For example, in some embodiments, a host information handling system 102 may include more than one energy storage device 116 and/or more than one memory 104.

A management module 112 may be configured to provide out-of-band management facilities for management of shared chassis infrastructure of system 100, such as air movers, PSUs 110, and/or other components shared by a plurality of host information handling systems 102. Such management may be made by management module 112 even if system 100 is powered off or powered to a standby state. Management module 112 may include a processor 113 and one or more memories 111. In certain embodiments, management module 112 may include or may be an integral part of an enclosure controller (EC). In other embodiments, management module 112 may include or may be an integral part of a chassis management controller (CMC).

Processor 113 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 113 may interpret and/or execute program instructions (e.g., firmware) and/or process data stored in memory 111 and/or another component of system 100 or management module 112. In some embodiments, processor 113 may comprise an enclosure controller configured to execute firmware relating to functionality as an enclosure controller. As shown in FIG. 1, processor 113 may include a network interface 114 for communicating with an internal network 118 of system 100.

Memory 111 may be communicatively coupled to processor 113 and may include any system, device, or apparatus configured to retain program instructions and/or data for a period of time (e.g., computer-readable media). Memory 111 may include RAM, EEPROM, a PCMCIA card, flash memory, magnetic storage, opto-magnetic storage, or any suitable selection and/or array of volatile or non-volatile memory that retains data after power to management module 112 is turned off.

Internal network 118 may comprise any suitable system, apparatus, or device operable to serve as communication infrastructure for network interfaces 114 to communicate to one another and one or more other components, such as baseboard management controllers 108 of host information handling systems 102.

At a given moment, one management module 112 may be “active” in that it is actively functional and performing its functionality, while another management module 112 is in a “standby” mode and may become active in the event that the active management module 112 experiences a fault or failure that causes it to failover to the standby management module 112.

Generally speaking, a PSU 110 may include any system, device, or apparatus configured to supply electrical current to one or more information handling resources of system 100. As shown in FIG. 1, a PSU 110 may provide electrical energy via (a) a main power rail, indicated in FIG. 1 as “MAIN POWER,” and (b) an auxiliary power rail, indicated in FIG. 1 as “AUX POWER.” The main power rail may generally be used to provide power to information handling resources of a host information handling system 102 when such host information handling system 102 is turned on and/or to provide power to certain components of system 100. On the other hand, the auxiliary power rail may generally be used to provide power to certain auxiliary information handling resources when energy is not supplied via the main power rail. For example, the auxiliary power rail may be used to provide power to baseboard management controller 108 when electrical energy is not provided to processor 103, memory 104, and/or other information handling resources via the main power rail. As another example, the auxiliary power rail may be used to provide power to management module 112 when electrical energy is not provided to host information handling resources 102 via the main power rail.

In some embodiments, a management module 112 may be configured to communicate with one or more PSUs 110 to communicate control and/or telemetry data between management module 112 and PSUs 110. For example, a PSU 110 may communicate information regarding status and/or health of such PSU 110 and/or measurements of electrical parameters (e.g., electrical currents or voltages) present within such PSU 110.

In addition to host information handling systems 102, management modules 112, internal network 118, and PSUs 110, system 100 may include one or more other information handling resources.

Further, while FIG. 1 depicts system 100 as having two persistent-memory equipped host information handling systems 102, it is understood that system 100 may be capable of receiving modular host information handling systems 102 of varying forms, functions, and/or structures. For example, in some embodiments, a host information handling system 102 present in system 100 may include only non-persistent memory.

In operation, a persistent-memory-equipped host information handling system 102 may be configured (e.g., via baseboard management controller 108 and save operation control logic 109) to recognize when its own energy storage device 116 has become degraded and responsive to determining that its own energy storage device 116 has become degraded, may isolate itself from the main power rail in order to protect other persistent-memory-equipped host information handling systems 102 from power disruption or power shutdown during a persistent memory save operation performed while host information handling systems 102 are powered from energy storage devices 116.

For instance, when a host information handling system 102 boots, it may be able to detect the presence of persistent memory 104 within the host information handling system 102 wherein the persistent memory 104 requires a localized power source—energy storage device 116—to achieve persistency (e.g., by execution of a save operation to transfer data from volatile memory 120 to non-volatile memory 122). During the course of the boot operation, save operation control logic 109 may determine if host information handling system 102 may arm its persistent memory 104 for a persistent memory save operation. In doing so, save operation control logic 109 may take into account one or more factors, including without limitation the ability of host information handling system 102 to detect a power loss condition, the health of energy storage device 116, and a health and a type of the persistent memory 104. Once host information handling system 102 is armed for a persistent memory save, and proceeds to runtime, the baseboard management controller 108 and save operation control logic 109 may monitor the health of energy storage device 116. If energy storage device 116 becomes unhealthy during runtime, baseboard management controller 108 may note this degraded condition, alert a user of the condition, and/or degrade the sled health.

Further, when host information handling system 102 arms for a persistent memory save operation, a save operation participation flag may be set by save operation control logic 109 (e.g., FLAG=1), indicating that if a power loss occurs (e.g., failure of one or more PSUs 110), the host information handling system 102 will participate in performing a save operation. Thus, while this flag is set for a host information handling system 102, such host information handling system 102 will be allowed to participate in any persistent memory save operation that is initiated due to power loss, virtual reset of host information handling system 102, or any other suitable event.

After being set, save operation control logic 109 may only clear (e.g., de-assert; FLAG=0) the save operation participation flag after a persistent memory save operation with respect to the host information handling system 102 or when the local energy storage device 116 of the host information handling system 102 becomes unhealthy during runtime and the host information handling system 102 includes persistent memory types that require a power source to maintain persistency (e.g., NVDIMM-N). In the event the host information handling system 102 includes only persistent memory types that do not require a power source to maintain persistency (e.g., Apache Pass (AEP)), the health of the local energy storage device may be ignored.

If a power loss occurs within chassis 101 while a save operation participation flag is cleared for a host information handling system 102, save operation control logic 109 of such host information handling system 102 may cause such host information handling system 102 to power off instead of allowing such host information handling system 102 to participate in a save operation. While this may likely result in data loss for the host information handling system 102 having the unhealthy energy storage device 116, persistent memory persistence on other host information handling systems 102 within chassis 101 may be preserved. Furthermore, if a local energy storage device 116 of a host information handling system 102 becomes degraded during a save operation, save operation control logic 109 may clear the save operation participation flag and take immediate action to power off the host information handling system 102, in order to reduce or eliminate impact to other host information handling systems 102, again such that persistent memory persistence on other host information handling systems 102 within chassis 101 may be preserved.

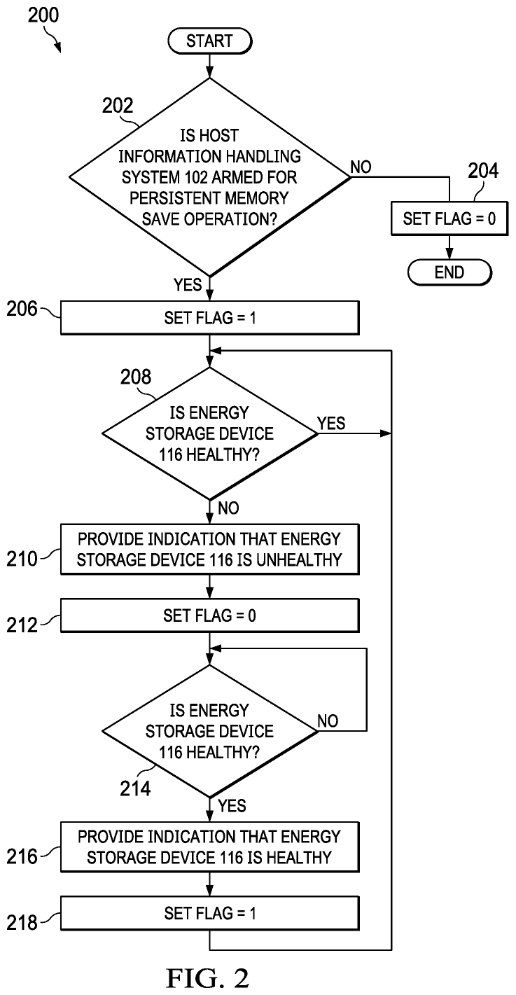

FIG. 2 illustrates a flow chart of an example method 200 for monitoring health of a local energy storage device 116 of a host information handling system 102, in accordance with embodiments of the present disclosure. According to some embodiments, method 200 may begin at step 202. As noted above, teachings of the present disclosure may be implemented in a variety of configurations of information handling system 102. As such, the preferred initialization point for method 200 and the order of the steps comprising method 200 may depend on the implementation chosen.

At step 202, after powering on and/or rebooting of a host information handling system 102, save operation control logic 109 may determine if the host information handling system 102 is armed for a persistent memory save operation. If the host information handling system 102 is armed for a persistent memory save operation, method 200 may proceed to step 206. Otherwise, method 200 may proceed to step 204.

At step 204, responsive to determining that the host information handling system 102 is not armed for a persistent memory save operation, save operation control logic 109 may clear the save operation participation flag for the host information handling system 102. After completion of step 204, method 200 may end until the information handling system is rebooted or power cycled.

At step 206, responsive to determining that the host information handling system 102 is armed for a persistent memory save operation, save operation control logic 109 may set the save operation participation flag for the host information handling system 102. At step 208, save operation control logic 109, alone or in cooperation with baseboard management controller 109, may determine if energy storage device 116 of the host information handling system 102 is healthy. If energy storage device 116 of the host information handling system 102 is healthy, method 200 may remain at step 208. Otherwise, method 200 may proceed to step 210.

At step 210, responsive to determining that energy storage device 116 of the host information handling system 102 is unhealthy, save operation control logic 109 and/or baseboard management controller 108 may provide an indication to a user (e.g., via a graphical user interface) that energy storage device 116 is unhealthy. At step 212, if any portion of memory 104 requires a local energy storage device 116 to perform a save operation, then save operation control logic 109 may clear the save operation participation flag for the host information handling system 102.

At step 214, save operation control logic 109, alone or in cooperation with baseboard management controller 109, may determine if energy storage device 116 of the host information handling system 102 is healthy. If energy storage device 116 of the host information handling system 102 is unhealthy, method 200 may remain at step 214. Otherwise, method 200 may proceed to step 216.

At step 216, responsive to determining that energy storage device 116 of the host information handling system 102 is healthy, save operation control logic 109 and/or baseboard management controller 108 may provide an indication to a user (e.g., via a graphical user interface) that energy storage device 116 is healthy. At step 218, if any portion of memory 104 requires a local energy storage device 116 to perform a save operation, then save operation control logic 109 may set the save operation participation flag for the host information handling system 102. After completion of step 218, method 200 may proceed again to step 208.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented using a host information handling system 102, management module 112, and/or any other system operable to implement method 200. In certain embodiments, method 200 may be implemented partially or fully in software and/or firmware embodied in computer-readable media.

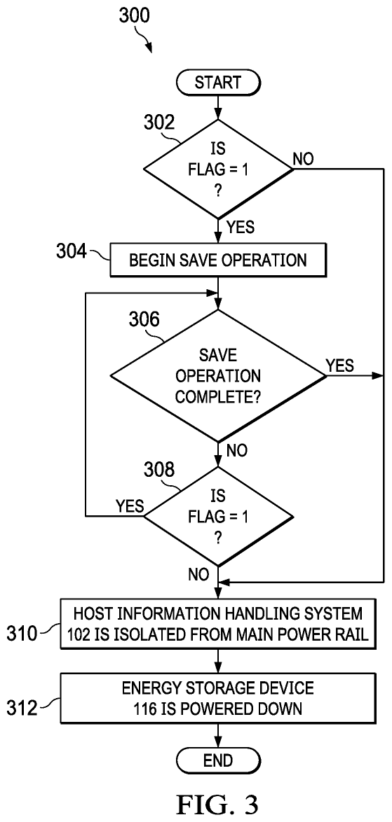

FIG. 3 illustrates a flow chart of an example method 300 for save operation by a host information handling system 102, in accordance with embodiments of the present disclosure. According to some embodiments, method 300 may begin at step 302. As noted above, teachings of the present disclosure may be implemented in a variety of configurations of information handling system 102. As such, the preferred initialization point for method 300 and the order of the steps comprising method 300 may depend on the implementation chosen.

At step 302, in response to an input source power event (e.g., failure of one or more PSUs 110), save operation control logic 109 may determine if the save operation participation flag is set. If the save operation participation flag is set, method 300 may proceed to step 304. Otherwise, method 300 may proceed to step 310.

At step 304, responsive to the save operation participation flag being set, host information handling system 102 may begin a save operation for its persistent memory 104. At step 306, during the save operation, save operation control logic 109 may determine if the save operation is complete. If the save operation is complete, method 300 may proceed to step 310. If the save operation is not complete, method 300 may proceed to step 308.

At step 308, responsive to a determination that the save operation is not complete, save operation control logic 109 may determine if the save operation participation flag is set. If the save operation participation flag is set, method 300 may proceed again to step 306. Otherwise, method 300 may proceed to step 310.

At step 310, responsive to the completion of a save operation or responsive to the save operation participation flag being cleared at the beginning of or during the save operation, save operation control logic 109 may cause the host information handling system 102 to electrically decouple from the main power rail of chassis 101, thus isolating the host information handling system 102 from the main power rail. At step 312, save operation control logic 109 may cause energy storage device 116 of the host information handling system to power down. After completion of step 312, method 300 may end.

Although FIG. 3 discloses a particular number of steps to be taken with respect to method 300, method 300 may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented using a host information handling system 102, management module 112, and/or any other system operable to implement method 300. In certain embodiments, method 300 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. A method comprising, in a chassis configured to provide a common hardware infrastructure to a plurality of modular information handling systems inserted into the chassis:
monitoring a health of a local energy storage device of a modular information handling system of the chassis during runtime of the modular information handling system; and
in the event of a power event of the chassis which triggers a persistent save operation for the plurality of modular information handling systems of the chassis:
allowing the modular information handling system to participate in the persistent save operation if the local energy storage device of the modular information handling system is healthy; and
disallowing the modular information handling system to participate in the persistent save operation if the local energy storage device of the modular information handling system is unhealthy.

2. The method of claim 1, wherein disallowing the modular information handling system to participate in the persistent save operation comprises electrically decoupling the modular information handling system from a power rail of the chassis common to the modular information handling system and other of the plurality of modular information handling systems of the chassis.

3. The method of claim 1, further comprising:
selectively setting or clearing a save operation participation flag responsive to monitoring of the health; and
allowing or disallowing the modular information handling system to participate in the persistent save operation based on the save operation participation flag.

4. The method of claim 1, wherein disallowing the modular information handling system to participate in the persistent save operation comprises disallowing the modular information handling system to participate in the persistent save operation at the beginning of the save operation.

5. The method of claim 1, wherein disallowing the modular information handling system to participate in the persistent save operation comprises disallowing the modular information handling system to participate in the persistent save operation after the save operation has begun.

6. An article of manufacture comprising:
a non-transitory computer-readable medium; and
computer-executable instructions carried on the computer-readable medium, the instructions readable by a processor, the instructions, when read and executed, for causing the processor to, in a chassis configured to provide a common hardware infrastructure to one or more modular information handling systems inserted into the chassis:
monitor a health of a local energy storage device of a modular information handling system of the chassis during runtime of the modular information handling system; and
in the event of a power event of the chassis which triggers a persistent save operation for the plurality of modular information handling systems of the chassis:
allow the modular information handling system to participate in the persistent save operation if the local energy storage device of the modular information handling system is healthy; and
disallow the modular information handling system to participate in the persistent save operation if the local energy storage device of the modular information handling system is unhealthy.

7. The article of claim 6, wherein disallowing the modular information handling system to participate in the persistent save operation comprises electrically decoupling the modular information handling system from a power rail of the chassis common to the modular information handling system and other of the plurality of modular information handling systems of the chassis.

8. The article of claim 6, the instructions for further causing the processor to:
selectively set or clear a save operation participation flag responsive to monitoring of the health; and
allow or disallow the modular information handling system to participate in the persistent save operation based on the save operation participation flag.

9. The article of claim 6, wherein disallowing the modular information handling system to participate in the persistent save operation comprises disallowing the modular information handling system to participate in the persistent save operation at the beginning of the save operation.

10. The article of claim 6, wherein disallowing the modular information handling system to participate in the persistent save operation comprises disallowing the modular information handling system to participate in the persistent save operation after the save operation has begun.

11. An information handling system comprising:
a chassis configured to provide a common hardware infrastructure to one or more modular information handling systems inserted into the chassis; and
a modular information handling system inserted into the chassis and configured to:
monitor a health of a local energy storage device of the modular information handling system during runtime of the modular information handling system; and
in the event of a power event of the chassis which triggers a persistent save operation for the plurality of modular information handling systems of the chassis:
allow the modular information handling system to participate in the persistent save operation if the local energy storage device of the modular information handling system is healthy; and
disallow the modular information handling system to participate in the persistent save operation if the local energy storage device of the modular information handling system is unhealthy.

12. The information handling system of claim 11, wherein disallowing the modular information handling system to participate in the persistent save operation comprises electrically decoupling the modular information handling system from a power rail of the chassis common to the modular information handling system and other of the plurality of modular information handling systems of the chassis.

13. The information handling system of claim 11, wherein the information handling system is further configured to:
selectively set or clear a save operation participation flag responsive to monitoring of the health; and
allow or disallow the modular information handling system to participate in the persistent save operation based on the save operation participation flag.

14. The information handling system of claim 11, wherein disallowing the modular information handling system to participate in the persistent save operation comprises disallowing the modular information handling system to participate in the persistent save operation at the beginning of the save operation.

15. The information handling system of claim 11, wherein disallowing the modular information handling system to participate in the persistent save operation comprises disallowing the modular information handling system to participate in the persistent save operation after the save operation has begun.
